(19) United States
(12) Patent Application Publication
(10) Pub. No.: US 2024/0403917 A1
(43) Pub. Date: Dec. 5, 2024

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventor: Tetsuro ISHII, Nagoya-shi (JP)

(73) Assignee: TOYOTA JIDOSHA KABUSHIKI KAISHA, Toyota-shi (JP)

(21) Appl. No.: 18/624,405

(22) Filed: Apr. 2, 2024

(30) Foreign Application Priority Data
Jun. 2, 2023 (JP) 2023-091879

(51) Int. Cl. G06Q 30/0251

(52) U.S. Cl. CPC G06Q 30/0266

(57) ABSTRACT

The information processing device determines a first facility that is within a predetermined range from a current position of the vehicle and is a candidate for proposing a visit to a user of the vehicle. Further, the information processing device acquires the first genre to which the first facility belongs. In addition, the information processing device acquires the second genre to which the facility visited by the vehicle within a predetermined period up to the present time belongs. Then, the information processing device determines whether the first genre matches the second genre. At this time, when determining that the first genre does not match the second genre, the information processing device outputs proposal information for proposing a visit of the first facility to the user.

### CROSS-REFERENCE TO RELATED APPLICATION

This application claims priority to Japanese Patent Application No. 2023-091879 filed on Jun. 2, 2023, incorporated herein by reference in its entirety.

### BACKGROUND

### 1. Technical Field

The present disclosure relates to an information processing device, an information processing method, and a storage medium.

### 2. Description of Related Art

Japanese Unexamined Patent Application Publication No. 2018-100890 (JP 2018-100890 A) discloses a providing device. The providing device disclosed in JP 2018-100890 A selects, from among candidates of visiting destinations, a visiting destination that satisfies a condition corresponding to a user visiting the visiting destination. The providing device then provides information to the user, indicating the visiting destination that is selected.

### SUMMARY

An object of the present disclosure is to propose visiting a facility that is suitable for a user.

An information processing device according to a first aspect of the present disclosure includes a control unit configured to execute
deciding a first facility that is within a predetermined range from a current position of a vehicle, and that is a candidate for making a proposal to a user of the vehicle to visit,
acquiring a first genre to which the first facility belongs,
acquiring a second genre to which belongs a facility, visited by the user within a predetermined period up to a present time using the vehicle,
determining whether the first genre matches the second genre,
outputting proposal information proposing visiting the first facility, to the user, when determination is made that the first genre does not match the second genre, and
not outputting the proposal information when determination is made that the first genre matches the second genre.

An information processing method according to a second aspect of the present disclosure is
an information processing method that is executed by a computer, the information processing method including
deciding a first facility that is within a predetermined range from a current position of a vehicle, and that is a candidate for making a proposal to a user of the vehicle to visit,
acquiring a first genre to which the first facility belongs,
acquiring a second genre to which belongs a facility, visited by the user within a predetermined period up to a present time using the vehicle,
determining whether the first genre matches the second genre,
outputting proposal information proposing visiting the first facility, to the user, when determination is made that the first genre does not match the second genre, and
not outputting the proposal information when determination is made that the first genre matches the second genre.

A storage medium according to a third aspect of the present disclosure is a storage medium storing a program for causing a computer to execute an information processing method,
the information processing method including
deciding a first facility that is within a predetermined range from a current position of a vehicle, and that is a candidate for making a proposal to a user of the vehicle to visit,
acquiring a first genre to which the first facility belongs,
acquiring a second genre to which belongs a facility, visited by the user within a predetermined period up to a present time using the vehicle,
determining whether the first genre matches the second genre,
outputting proposal information proposing visiting the first facility, to the user, when the first genre does not match the second genre, and
not outputting the proposal information when the first genre matches the second genre.

According to the present disclosure, visiting a facility that is suitable for the user can be proposed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a proposed system;

FIG. 2 is a block diagram schematically illustrating an example of a functional configuration of a server according to the present embodiment;

FIG. 3 is a diagram illustrating an example of a table configuration of facility information held in a facility information database;

FIG. 4 is a diagram illustrating an example of a table configuration of history information held in a history information database;

FIG. 5 is a diagram illustrating an example of a table configuration of user information held in a user information database;

FIG. 6 is a flow chart of a first process executed by a control unit of the server; and

FIG. 7 is a flowchart of a second process executed by the control unit of the server.

### DETAILED DESCRIPTION OF EMBODIMENTS

Here, it is assumed that the information processing device proposes to the user a visit to a facility existing within a predetermined range from the current position of the vehicle. At this time, if the user of the vehicle recently visits a facility belonging to the same genre, the user may not visit a facility belonging to the same genre again. On the other hand, although the user of the vehicle has recently visited a facility belonging to the same genre, the information processing device may propose a visit to a facility belonging to the same genre. As a result, unnecessary proposals are made for visiting the facility, and the user feels troublesome. An information processing device according to a first aspect of the present disclosure solves such a problem.

The control unit of the information processing device according to the first aspect of the present disclosure determines the first facility. Here, the first facility is a facility existing within a predetermined range from the current position of the vehicle, and is a candidate for proposing a visit to the user of the vehicle. Further, the control unit of the information processing device acquires the first genre to which the first facility belongs.

In addition, the control unit acquires the second genre to which the facility visited by the vehicle within a predetermined period up to the present time belongs. The control unit determines whether the first genre matches the second genre. At this time, when determining that the first genre does not match the second genre, the control unit outputs proposal information for proposing a visit of the first facility to the user. In addition, when determining that the first genre matches the second genre, the control unit does not output the proposal information.

As described above, the information processing device according to the first aspect of the present disclosure outputs the proposal information when the first genre does not match the second genre. In other words, when the user does not visit the facility of the same genre as the first genre within a predetermined period of time, the proposal information is output. When the first genre matches the second genre, the proposal information is not output. In other words, when the user visits a facility in the same genre as the first genre within a predetermined period of time, the proposal information is not output.

Accordingly, it is possible to output proposal information about a facility of a genre that is not visited by the user within a predetermined period. As a result, it is possible to propose a visit to a facility suitable for the user.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### System Overview

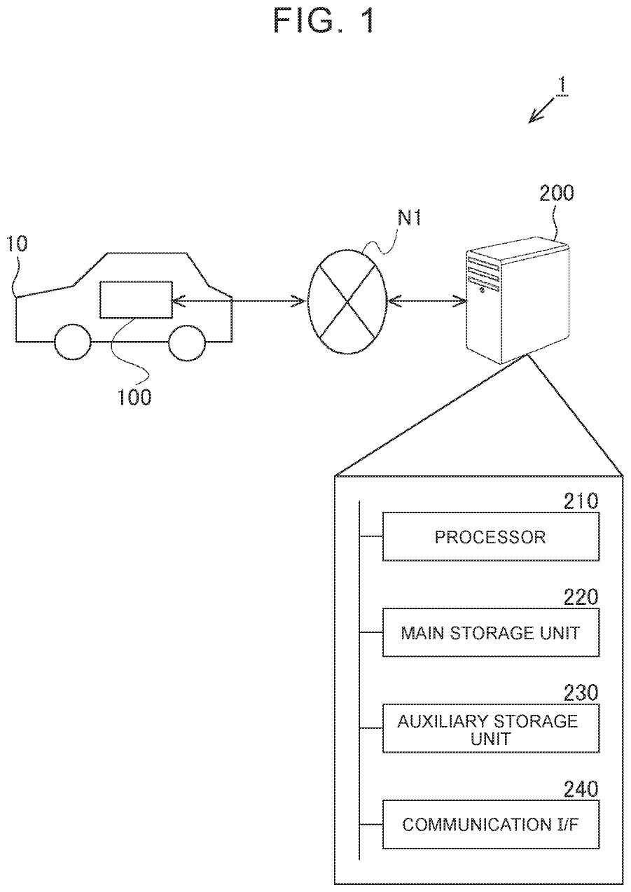

The proposal system 1 according to the present embodiment will be described with reference to FIG. 1. FIG. 1 is a diagram illustrating a schematic configuration of a proposal system 1. The proposal system 1 includes an in-vehicle device 100 and a server 200. In the proposal-system 1, the in-vehicle device 100 and the servers 200 are connected to each other by a network N1. The network N1 may employ, for example, a Wide Area Network (WAN) which is a global public communication network such as the Internet, or a telephone communication network such as a cellular telephone.

### In-Vehicle Device

The in-vehicle device 100 is an in-vehicle device mounted on the vehicle 10. The in-vehicle device 100 provides various kinds of information to the user of the vehicle 10. The in-vehicle device 100 receives proposal data from the servers 200 via the network N1. Here, the proposal information is information for proposing a visit of a facility to a user. Upon receiving the proposal information, the in-vehicle device 100 displays information for proposing a visit to the facility to the user on the display. In addition, upon receiving the proposal information, the in-vehicle device may notify the user of information for proposing a visit to the facility by voice.

In addition, the in-vehicle device 100 acquires the current position of the vehicle 10 from the navigation system mounted on the vehicle 10. Then, the in-vehicle device 100 transmits the acquired position information including the current position of the vehicle 10 to the server 200 in real time.

### Server

The server 200 is a server for proposing a visit of a facility to a user of the vehicle 10. The server 200 receives the position information of the vehicle 10 from the in-vehicle device 100 in real time.

Here, it is assumed that the server 200 proposes a visit to a facility existing within a predetermined range from the current position of the vehicle 10. At this time, if the user of the vehicle 10 recently visits a facility belonging to the same genre, the user may not visit a facility belonging to the same genre again. On the other hand, although the user of the vehicle 10 has recently visited a facility belonging to the same genre, the server 200 may propose a visit to a facility belonging to the same genre. As a result, unnecessary proposals are made for visiting the facility, and the user of the vehicle 10 feels troublesome.

For example, assume that a user has recently visited a supermarket and shopped. At this time, if a visit to the supermarket is proposed again despite the fact that shopping has already been completed, the user of the vehicle 10 may feel troublesome.

Therefore, the server 200 proposes a visit to a facility belonging to a genre different from the facility visited by the vehicle 10 within a predetermined period up to the present time by the user of the vehicle 10. Further, the server 200 does not propose a visit to a facility belonging to the same genre as the facility visited by the vehicle 10 within a predetermined period up to the present time by the user of the vehicle 10. Here, in the present embodiment, the predetermined period is a predetermined period such as, for example, one day. Details of a method for the server 200 to propose a visit of a facility to a user of the vehicle 10 will be described later.

The servers 200 are configured to include a processor 210, a main storage unit 220, an auxiliary storage unit 230, and communication interfaces (computers having communication I/F) 240. The processor 210 is, for example, Central Processing Unit (CPU) or Digital Signal Processor (DSP). The main storage unit 220 is, for example, a Random Access Memory (RAM). The auxiliary storage unit 230 is, for example, a Read Only Memory (ROM). The auxiliary storage unit 230 is, for example, a Hard Disk Drive (HDD), a CD-ROM, DVD disc, or a disc recording medium such as a Blu-ray disc. The auxiliary storage unit 230 may be a removable medium (a portable storage medium). Examples of the removable medium include a USB memory or an SD card. The communication I/F 240 is, for example, a Local Area Network (LAN) interface board or wireless communication circuitry for wireless communication.

In the servers 200, an operating system (OS), various programs, various information tables, and the like are stored in the auxiliary storage unit 230. Further, in the server 200, the processor 210 loads the program stored in the auxiliary storage unit 230 into the main storage unit 220 and executes the program, thereby realizing various functions as described later. However, some or all of the functions of the servers 200 may be implemented by hardware circuitry such as ASIC or FPGA. Note that the server 200 does not necessarily have to be realized by a single physical configuration, and may be constituted by a plurality of computers that cooperate with each other. Similarly to the server 200, the in-vehicle device 100 includes a computer.

### Functional Configuration

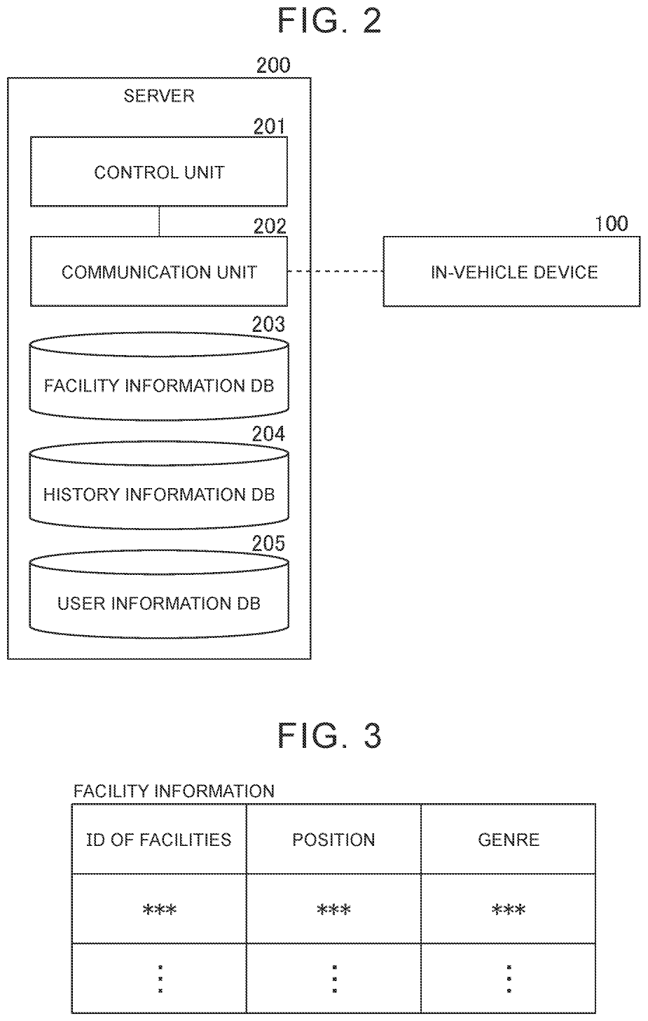

Next, a functional configuration of the server 200 configuring the proposal system 1 according to the present embodiment will be described with reference to FIG. 2 to FIG. 5. FIG. 2 is a block diagram schematically illustrating an example of a functional configuration of the server 200 according to the present embodiment.

The server 200 includes a control unit 201, a communication unit 202, a facility information database 203 (facility information DB 203), a history information database 204 (history information DB 204), and a user information database 205 (user information DB 205).

The control unit 201 has a function of performing arithmetic processing for controlling the server 200. The control unit 201 can be realized by the processor 210 in the server 200. The communication unit 202 has a function of connecting the servers 200 to a network N1. The communication unit 202 can be realized by a communication I/F 240 in the servers 200.

The facility information DB 203 has a function of holding facility information. The facility information is information indicating a location of a facility existing in a predetermined area and a genre to which the facility belongs. The facility-information DB 203 can be realized by the auxiliary storage unit 230 in the servers 200. FIG. 3 is a diagram illustrating an exemplary table configuration of facility information held in the facility information DB 203.

As illustrated in FIG. 3, the facility data includes a facility ID field, a location field, and a genre field. In the facility ID field, an identifier (facility ID) for identifying a facility existing in a predetermined area is stored. The location field stores information indicating the location of the facility corresponding to the facility ID stored in the facility ID field. The genre field stores information indicating a genre to which the facility corresponding to the facility ID stored in the facility ID field belongs. The genre field stores information indicating a genre of a facility such as a theme park, a park, a restaurant, a convenience store, or a supermarket.

The control unit 201 receives the position information of the vehicle 10 from the in-vehicle device 100 in real time from the in-vehicle device 100. Therefore, the control unit 201 refers to the facility information held in the facility information DB 203 and the position information of the vehicle 10, and identifies the facility visited by the vehicle 10 by the user. Then, the control unit 201 stores information about the identified facilities in the history information DB 204.

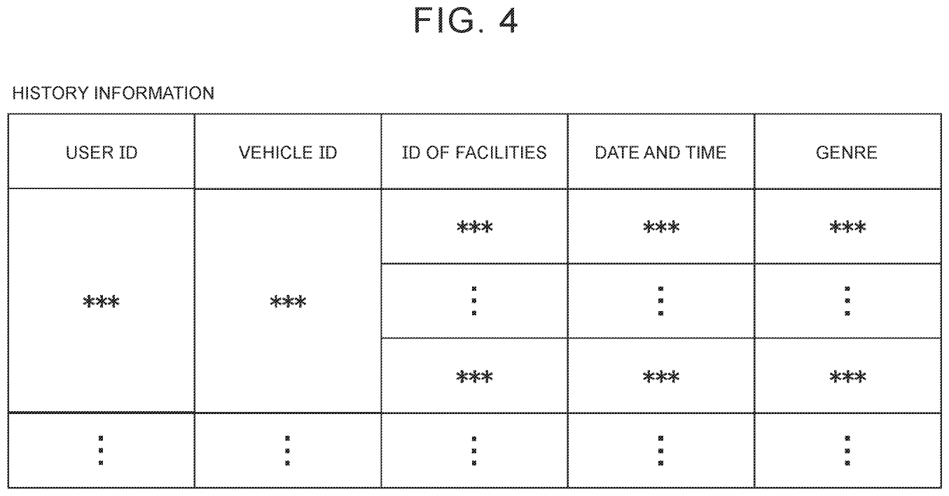

The history information DB 204 has a function of holding history information. The history information is information indicating a facility visited by the user by the vehicle. The history-information DB 204 can be realized by the auxiliary storage unit 230 in the servers 200. FIG. 4 is a diagram illustrating an exemplary table configuration of the history information held in the history information DB 204.

As shown in FIG. 4, the history information has a user ID field, a vehicle ID field, a facility ID field, a time-of-day field, and a genre field. In the user ID field, an identifier (user ID) for identifying a user is stored. In the vehicle ID field, an identifier (vehicle ID) for specifying a vehicle used by the user corresponding to the user ID stored in the user ID field is stored. In the facility ID field, facility ID of a facility visited by the user corresponding to the user ID stored in the user ID field by the vehicle corresponding to the vehicle ID stored in the vehicle ID field is stored.

Here, the control unit 201 can grasp the current position of the vehicle 10 by referring to the position information of the vehicle 10 received from the in-vehicle device 100. Therefore, the control unit 201 refers to the facility information held in the facility information DB 203 to identify the facility visited by the vehicle 10 by the user. Specifically, the control unit 201 specifies that the vehicle 10 is visiting the facility located at the position when it is detected that the vehicle 10 is stopped for a predetermined time or longer at the position indicated by the information stored in the position field of the facility information. The control unit 201 acquires the facility ID of the specified facility from the facility information held in the facility information DB 203. Then, the control unit 201 enters the acquired facility ID in the facility ID field in the history information.

The date and time field stores information indicating the date and time when the user visits the facility stored in the facility ID field. The control unit 201 refers to the position information of the vehicle 10 received from the in-vehicle device 100, and specifies the time when the user arrives at the facility visited by the vehicle 10. Then, the control unit 201 stores the information indicating the time when the user arrives at the facility visited by the vehicle 10 in the date and time field as the information indicating the date and time when the user visits the facility. Further, the control unit 201 may store, in the date and time field, information indicating the time when the user departs from the facility visited by the vehicle 10 or the time period during which the user has stopped at the facility, as information indicating the date and time when the user visited the facility.

The genre field stores information indicating a genre to which the facility corresponding to the facility ID held in the facility ID field belongs. The control unit 201 refers to the facility information held in the facility information DB 203, and acquires information indicating the genre to which the facility corresponding to the facility ID held in the facility ID field belongs. Then, the control unit 201 stores information indicating the acquired genre in the genre field in the history information held in the history information DB 204.

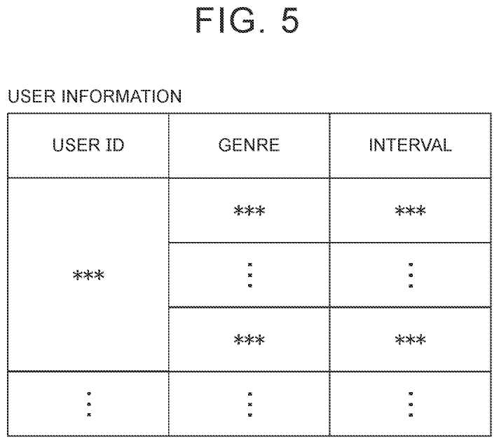

The user information DB 205 has a function of holding user information. The user information is information indicating a genre of a facility that proposes a visit to the user. The user information DB 205 can be realized by the auxiliary storage unit 230 in the servers 200. FIG. 5 is a diagram illustrating an exemplary table configuration of user information held in the user information DB 205.

As shown in FIG. 5, the user data includes a user ID field, a genre field, and a spacing field. In the user ID field, user ID is stored. The genre field stores information indicating a genre to which a facility that proposes a visit to the user held in the user ID field belongs.

The control unit 201 refers to the history information held in the history information DB 204, and determines the genre to which the facilities that propose a visit to the user of the vehicle 10 belong. For example, when the user of the vehicle 10 visits a facility of the same genre for a predetermined number of times or more in the history information, the control unit 201 stores information indicating the genre in the genre field in the user information stored in the user information DB 205.

In addition, for example, when the user of the vehicle 10 visits a facility of the same genre for a predetermined number of times or more in the history information, the control unit 201 may store information indicating a genre related to the genre in a genre field in the user information stored in the user information DB 205. For example, it is assumed that the types of products sold by the convenience store and the supermarket are similar to each other. Therefore, it can be assumed that the convenience store and the supermarket are predetermined as related genres. Therefore, when the user of the vehicle 10 visits the facility of the convenience store for a predetermined number of times or more, the control unit 201 stores the supermarket in the genre field in the user information held in the user information DB 205 in addition to the convenience store.

In the interval field, information indicating an interval at which a user visits a facility belonging to a genre corresponding to information stored in a genre field (hereinafter, sometimes referred to as “interval information”) is stored. The control unit 201 refers to the history information held in the history information DB 204, and calculates an average of the intervals at which the user visits the facilities for each genre in the genre field. Then, the control unit 201 stores information indicating an average value of the intervals calculated in the interval field.

The control unit 201 refers to the position information of the vehicle 10 and the facility information held in the facility information DB 203, and identifies one or a plurality of facilities existing within a predetermined area from the present position of the vehicle 10. The control unit 201 refers to the user information and acquires a genre of a facility that proposes a visit to the user. The control unit 201 determines a facility whose genre matches the acquired genre among one or a plurality of facilities existing within a predetermined range from the current position of the vehicle 10 as a facility (hereinafter, may be referred to as a “first facility”) that is a candidate for proposing a visit to the user of the vehicle 10. Further, the control unit 201 refers to the facility information and acquires a genre to which the first facility belongs (hereinafter, may be referred to as a “first genre”).

The control unit 201 refers to the history information held in the history information DB 204, and specifies a facility (hereinafter, sometimes referred to as a “second facility”) visited by the user by the vehicle 10 within a predetermined time until now. Further, the control unit 201 refers to the history information and acquires a genre to which the second facility belongs (hereinafter, may be referred to as a “second genre”).

The control unit 201 determines whether or not the first genre and the second genre match each other. When the first genre and the second genre do not coincide with each other, the control unit 201 outputs proposal information (hereinafter, may be simply referred to as “proposal information”) suggesting that the user of the vehicle 10 visit the first facility to the in-vehicle device 100. The control unit 201, the control unit 201, when the first genre and second genre is consistent, does not output the proposed information to the in-vehicle device 100.

Here, there may be a plurality of second genres due to the presence of a plurality of second facilities having different genres. In this case, the control unit 201 determines whether or not the first genre and the genre match each other with respect to the plurality of second genres. When all of the plurality of second genres do not match the first genre, the control unit 201 outputs the proposal information to the in-vehicle device 100. In addition, when there is a second genre that matches the first genre among the plurality of second genres, the control unit 201 does not output the proposal information about the second facility belonging to the second genre.

In addition, when there are a plurality of first facilities having different genres, the control unit 201 determines whether or not the second genre matches the genre for each of the first genres. Then, the control unit 201 determines whether or not to output the proposal information for the first facility belonging to each first genre, based on the determination result of whether or not the genre matches the second genre.

### (Flowchart)

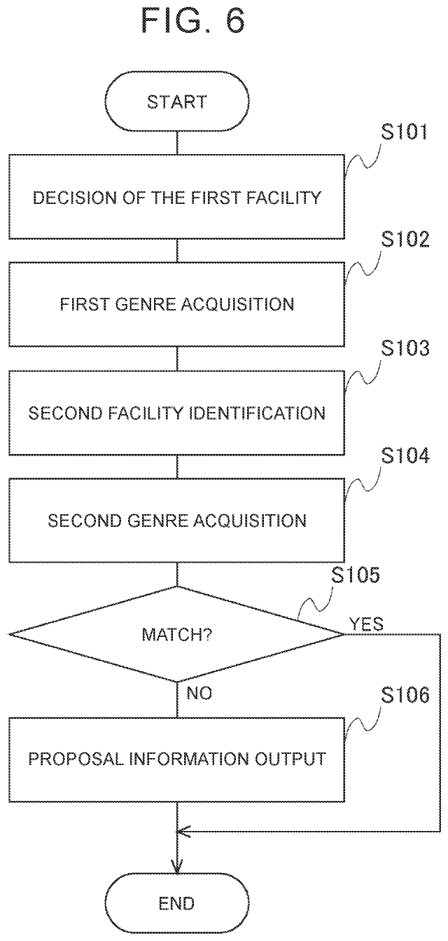

Next, a first process executed by the control unit 201 in the server 200 in the proposal system 1 will be described with reference to FIG. 6. FIG. 6 is a flowchart of a first process executed by the control unit 201. The processing is processing for determining whether or not to output the proposal information to the in-vehicle device 100, and outputting the proposal information to the in-vehicle device 100 based on the determination result. The process is executed in real time.

In the process illustrated in FIG. 6, first, in S101, the location information of the vehicle 10, the facility information held in the facility information DB 203, and the user information held in the user information DB 205 are referred to, and the first facility is determined. Next, in S102, the first genre is obtained from the facility info.

Next, in S103, the history information held in the history information DB 204 is referred to, and the second facility is identified. Next, in S104, a second genre is obtained from the historical data. Next, in S105, it is determined whether the first genre matches the second genre. When an affirmative determination is made in S105, the user visits a facility (second facility) belonging to the second genre by the vehicle 10 within a predetermined time. Therefore, when the proposal information is output to the in-vehicle device 100 in spite of visiting the facility of the same genre within a predetermined period, it is assumed that the user feels troublesome. Therefore, when an affirmative determination is made in S105, the process illustrated in FIG. 6 is temporarily ended.

When a negative determination is made in S105, the user does not visit the facilities (first facilities) belonging to the first genre by the vehicle 10 within a predetermined time. Therefore, the proposal information is output to the in-vehicle device 100. Then, the processing illustrated in FIG. 6 is temporarily ended.

As described above, in the proposal system 1, when the first genre does not match the second genre, the proposal information is output. In other words, when the user does not visit the facility of the same genre as the first genre within a predetermined period of time, the proposal information is output. Further, in the proposal system 1, when the first genre matches the second genre, the proposal information is not output. In other words, when the user visits the facility of the same genre as the first genre within a predetermined period by the vehicle 10, the proposal information is not output. Accordingly, it is possible to output proposal information about a facility of a genre that is not visited by the user within a predetermined period. As a result, it is possible to propose a visit to a facility suitable for the user.

### First Modification

When the genres are different, it is assumed that the intervals at which the user visits the facilities belonging to the genres are different. Therefore, in the present modification, the predetermined period is set as a predetermined period for each first genre. As described above, even if the intervals for visiting the facilities belonging to each genre are different, since a predetermined period is determined for each genre, it is possible to output the proposal information to the in-vehicle device 100 at a time suitable for the server 200 to visit the first facility for the user.

### Second Modification

In addition, the server 200 may determine a predetermined period by referring to the interval information stored in the interval field of the user information held in the user information DB 205. In this case, the server 200 determines a predetermined period of time so that the time interval from the start time to the present time coincides with the interval indicated by the interval information.

### (Flowchart)

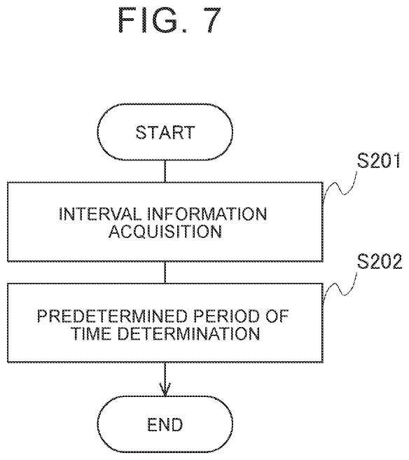

Next, a second process executed by the control unit 201 in the server 200 in the proposal system 1 will be described with reference to FIG. 7. FIG. 7 is a flowchart of a second process executed by the control unit 201. The process is a process for determining a predetermined period for the first genre. This processing is started after the processing of S102 shown in FIG. 6 is executed.

In the process illustrated in FIG. 7, in S201, the spacing information corresponding to the first genre acquired by S102 in the process illustrated in FIG. 6 is acquired from the user information held in the user information DB 205. Next, in S202, the interval data is referred to, and a predetermined duration corresponding to the first genre acquired by S102 in the process illustrated in FIG. 6 is determined. Then, the process illustrated in FIG. 7 is ended, and the process of S103 illustrated in FIG. 6 is executed. Here, a facility visited by the user within a predetermined period corresponding to the first genre by the vehicle 10 is identified as the second facility.

Even in this manner, a predetermined period can be determined for each first genre. As a result, the server 200 can output the proposal information to the in-vehicle device 100 at a time suitable for the user to visit the first facility.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk such as a magnetic disk (a floppy (registered trademark) disk, an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device, comprising: a control unit configured to execute
deciding a first facility that is within a predetermined range from a current position of a vehicle, and that is a candidate for making a proposal to a user of the vehicle to visit;
acquiring a first genre to which the first facility belongs;
acquiring a second genre to which belongs a facility, visited by the user within a predetermined period up to a present time using the vehicle;
determining whether the first genre matches the second genre;
outputting proposal information proposing visiting the first facility, to the user, when determination is made that the first genre does not match the second genre; and
not outputting the proposal information when determination is made that the first genre matches the second genre.

2. The information processing device according to claim 1, wherein:
a plurality of the first genre exists; and
the predetermined period is set as a period set in advance for each first genre.

3. The information processing device according to claim 1, wherein:
the control unit is configured to further execute acquiring an interval at which the user has visited a facility belonging to the first genre using the vehicle; and
the control unit is further configured to execute deciding of the predetermined period such that a time interval from a beginning to the present time coincides with the interval.

4. An information processing method that is executed by a computer, the information processing method comprising:
deciding a first facility that is within a predetermined range from a current position of a vehicle, and that is a candidate for making a proposal to a user of the vehicle to visit;
acquiring a first genre to which the first facility belongs;
acquiring a second genre to which belongs a facility, visited by the user within a predetermined period up to a present time using the vehicle;
determining whether the first genre matches the second genre;
outputting proposal information proposing visiting the first facility, to the user, when determination is made that the first genre does not match the second genre; and
not outputting the proposal information when determination is made that the first genre matches the second genre.

5. A non-transitory storage medium storing a program for causing a computer to execute an information processing method, the information processing method including:
deciding a first facility that is within a predetermined range from a current position of a vehicle, and that is a candidate for making a proposal to a user of the vehicle to visit;
acquiring a first genre to which the first facility belongs;
acquiring a second genre to which belongs a facility, visited by the user within a predetermined period up to a present time using the vehicle;
determining whether the first genre matches the second genre;
outputting proposal information proposing visiting the first facility, to the user, when the first genre does not match the second genre; and
not outputting the proposal information when the first genre matches the second genre.
